(19) United States
(12) Patent Application Publication
(10) Pub. No.: US 2015/0173420 A1
(43) Pub. Date: Jun. 25, 2015

(54) ELECTRONIC CIGARETTE USING MAGNETIC CONNECTION

(71) Applicant: SHENZHEN BEAUTIFUL TECHNOLOGY CO., LTD, Shenzhen (CN)

(72) Inventor: Wuqiang SHI, Shenzhen (CN)

(21) Appl. No.: 14/268,573

(22) Filed: May 2, 2014

Related U.S. Application Data
(63) Continuation of application No. PCT/CN2014/072603, filed on Feb. 27, 2014.

(30) Foreign Application Priority Data
Mar. 20, 2013 (CN) 201320126047.3

(51) Int. Cl. A24F 47/00; H01R 13/62

(52) U.S. Cl. CPC A24F 47/008; H01R 13/6205

(57) ABSTRACT

The present invention relates to an electronic cigarette, and more particularly, to an electronic cigarette using a magnetic connection, the electronic cigarette includes a mouth-piece, an atomizer component and a power supply component, the mouth-piece is arranged at an end of the atomizer component, the other end of the atomizer component is magnetically connected to an end of the power supply component. The connection between the power supply component and atomizer component is changed to a magnetic connection, the magnetic connection is convenient for disassemble and assemble of the electronic cigarette, therefore, the time for disassemble and assemble can be greatly saved, and the magnetic connection can be used for a long time.

### BACKGROUND OF THE INVENTION

1. Technical Field

The present invention relates to an electronic cigarette, and more particularly, to an electronic cigarette using a magnetic connection.

2. Description of Related Art

An electronic cigarette that is also known as a virtual cigarette or electronic atomizer is mainly used for smoking cessation and replacing a cigarette, the electronic cigarette has the same appearance with a cigarette, the similar taste with a cigarette, and even more flavor than a general cigarette. Liquid for producing vapor used in the electronic cigarette is mainly made from plant extracts, water, food flavorings. Generally, the liquid is stored in a bottle.

All of the electronic cigarettes in the prior art adopt threaded connections, thread lengths and thread pitches of the threaded connections are generally short on the one hand and on the other hand the connection between the power supply component and atomizer component is disassembled and assembled frequently due to the filling of the liquid, therefore, the threads are easy to be worn away, thus the threads will be mismatched or deadlocked. In addition, the assembly of the threaded connection also takes more time.

### BRIEF SUMMARY OF THE INVENTION

A technical problem to be solved by the present invention is to overcome the shortcomings of the prior art and provide an electronic cigarette using a magnetic connection, the magnetic connection is convenient for disassemble and assemble of the electronic cigarette, therefore, the time for the disassemble and assemble can be greatly saved, and the magnetic connection can be used for a long time.

The present invention adopts the following technical solutions to solve the technical problem: an electronic cigarette using a magnetic connection, the electronic cigarette includes a mouth-piece, an atomizer component and a power supply component, the mouth-piece is arranged at an end of the atomizer component, the other end of the atomizer component is magnetically connected to an end of the power supply component.

In one embodiment, a first magnetic part is arranged in the magnetic connecting end of the atomizer component, a second magnetic part attracted by the first magnetic part is arranged in the magnetic connecting end of the power supply component, the atomizer component is magnetically connected to the power supply component by the attraction between the first magnetic part and the second magnetic part.

In one embodiment, a magnetic part is arranged in the magnetic connecting end of the atomizer component, the magnetic connecting end of the power supply component is a metallic connecting end attracted by the magnetic part.

In one embodiment, a magnetic part is arranged in the magnetic connecting end of the power supply component, the magnetic connecting end of the atomizer component is a metallic connecting end attracted by the magnetic part.

In one embodiment, both magnetic connecting ends of the atomizer component and the power supply component are flat.

In one embodiment, a magnetic connecting end of the atomizer component is provided with a protrusion, a groove is defined in a magnetic connecting end of the power supply component, the protrusion is engaged in the groove via a fastening connection.

In one embodiment, a groove is defined in a magnetic connecting end of the atomizer component, a magnetic connecting end of the power supply component is provided with a protrusion, the protrusion is engaged in the groove via a fastening connection.

In one embodiment, a magnetic connecting end of the atomizer component is connected to a magnetic connecting end of the power supply component via a plurality of fastening connections.

The present invention has the following benefits: the electronic cigarette using a magnetic connection according to the present invention includes a mouth-piece, an atomizer component and a power supply component, the mouth-piece is arranged at an end of the atomizer component, the other end of the atomizer component is magnetically connected to an end of the power supply component. The connection between the power supply component and atomizer component is changed to the magnetic connection, the magnetic connection is convenient for disassemble and assemble, therefore, the time for disassemble and assemble can be greatly saved, and the magnetic connection can be used for a long time.

### BRIEF DESCRIPTION OF THE SEVERAL VIEWS OF THE DRAWINGS

FIG. 1 is a schematic structure diagram of a first embodiment according to the present invention;

FIG. 2 is a schematic structure diagram of a second embodiment according to the present invention;

FIG. 3 is a schematic structure diagram of a third embodiment according to the present invention;

FIG. 4 is a schematic structure diagram of a fourth embodiment according to the present invention;

FIG. 5 is a schematic structure diagram of a fifth embodiment according to the present invention; and

FIG. 6 is a schematic structure diagram of a sixth embodiment according to the present invention.

### DETAILED DESCRIPTION OF THE INVENTION

The present invention will be explained below in detail with reference to the accompanying drawings.

A First Embodiment:

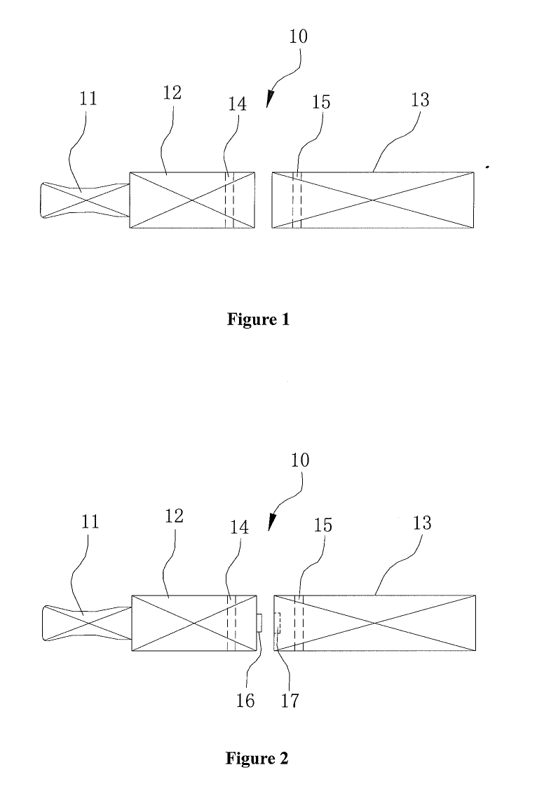

Referring to FIG. 1, an electronic cigarette 10 using a magnetic connection according to present invention includes a mouth-piece 11, an atomizer component 12 and a power supply component 13, the mouth-piece 11 is arranged at an end of the atomizer component 12, the other end of the atomizer component 12 is magnetically connected to an end of the power supply component 13.

In the electronic cigarette 10 according to the present invention, the power supply component 13 is magnetically connected to the atomizer component 12, so that the connection between the power supply component 13 and the atomizer component 12 is changed from a traditional threaded connection to a magnetic connection. The magnetic connection is convenient for disassemble and assemble of the electronic cigarette, therefore, the time for disassemble and assemble can be greatly saved, and the magnetic connection can be used for a long time.

Continue to refer to FIG. 1, both connecting ends of the atomizer component 12 and the power supply component 13 are flat, therefore, the structure of connecting ends is simplified, the cost is low.

Further, a first magnetic part 14 is arranged in the magnetic connecting end of the atomizer component 12, a second magnetic part 15 attracted by the first magnetic part 14 is arranged in the magnetic connecting end of the power supply component 13, the atomizer component 12 is magnetically connected to the power supply component 15 by the attraction between the first magnetic part 14 and the second magnetic part 15. The first magnetic part 14 and the second magnetic part 15 are permanent magnets, not only the permanent magnets are easy to get and moderate in price, but also the connection and separation between the atomizer component 12 and the power supply component 13 can be ensured through the attraction between the first magnetic part 14 and the second magnetic part 15.

Furthermore, in order to improve the safety and health of the electronic cigarette, an outside surface of the mouth-piece 11 is coated by nano silver, the nano silver is metallic elemental silver with nanometer diameter. In particular, the diameter of the nano silver is about 25 nm, the nano silver can slow down the growth and weakly kill dozens of pathogenic microorganisms, such as escherichia coli, gonococci and chlamydia trachomatis, at the same time, resistance to drugs will not be developed.

A Second Embodiment:

Referring to FIG. 2, the second embodiment and the first embodiment are largely identical but with minor differences. In particular, with regard to the second embodiment, the first embodiment can be referred, the second embodiment will not be described in detail and is different from the first embodiment, and the differences lie in:

The magnetic connecting end of the atomizer component 1 is provided with a protrusion 16, a groove 17 is defined in the magnetic connecting end of the power supply component 13, the protrusion 16 is connected to the groove 17 via a fastening connection, therefore, the protrusion 16 and the groove 17 can be aligned for their connection.

A Third Embodiment:

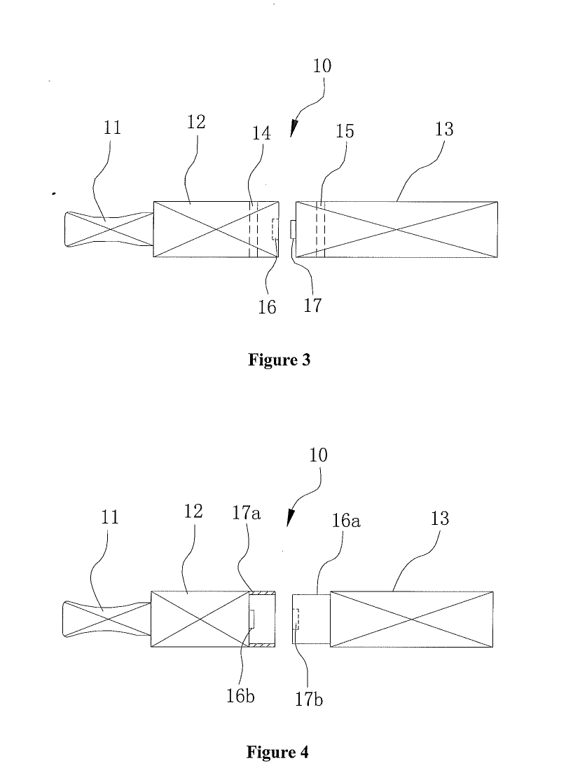

Referring to FIG. 3, the third embodiment and the second embodiment are largely identical but with minor differences. In particular, with regard to the third embodiment, the second embodiment can be referred, the third embodiment will not be described in detail, and it is different from the second embodiment, the differences lie in:

A groove 17 is defined in the magnetic connecting end of the atomizer component 12, the magnetic connecting end of the power supply component 13 is provided with a protrusion 16, the protrusion 16 is connected to the groove 17 via a fastening connection, therefore, the protrusion 16 and the groove 17 can be aligned for their connection.

A Fourth Embodiment:

Referring to FIG. 4, the fourth embodiment and the first embodiment are largely identical but with minor differences. In particular, with regard to the fourth embodiment, the first embodiment can be referenced, the fourth embodiment will not be described in detail, and it is different from the first embodiment, the differences lie in:

In particular, the magnetic connecting end of the atomizer component 12 is connected to the magnetic connecting end of the power supply component 13 by a plurality of fastening connections between the protrusions and the grooves, the plurality of fastening connections strengthen the tightness between the atomizer component 12 and the power supply component 13, and ensure the accuracy of the connections.

Preferably, the magnetic connecting end of the power supply component 13 is provided with a first protrusion 16a, a second groove 17b is defined in the first protrusion 16a, the magnetic connecting end of the atomizer component 12 defines a first groove 17a correspondingly connected to the first protrusion 16a via a fastening connection, the first groove 17a is provided with a second protrusion 16b correspondingly connected to the second groove 17b via a fastening connection. In order to optimize the electronic cigarette, considering cost budget of electronic cigarette, the tightness between the atomizer component 12 and the power supply component 13 can be better ensured by only two fastening connections between the first protrusion 16a and the first groove 16a and between the second protrusion 16b and the second groove 17b.

Alternatively, the magnetic connecting end of the atomizer component 12 is provided with a first protrusion 16a, a second groove 17b is defined on the first protrusion 16a, a first groove 17a correspondingly connected to the first protrusion 16a via a fastening connection is defined in the magnetic connecting end of the power supply component 13, the first groove 17a is provided with a second protrusion 16b correspondingly connected to the second groove 17b via a fastening connection.

A Fifth Embodiment:

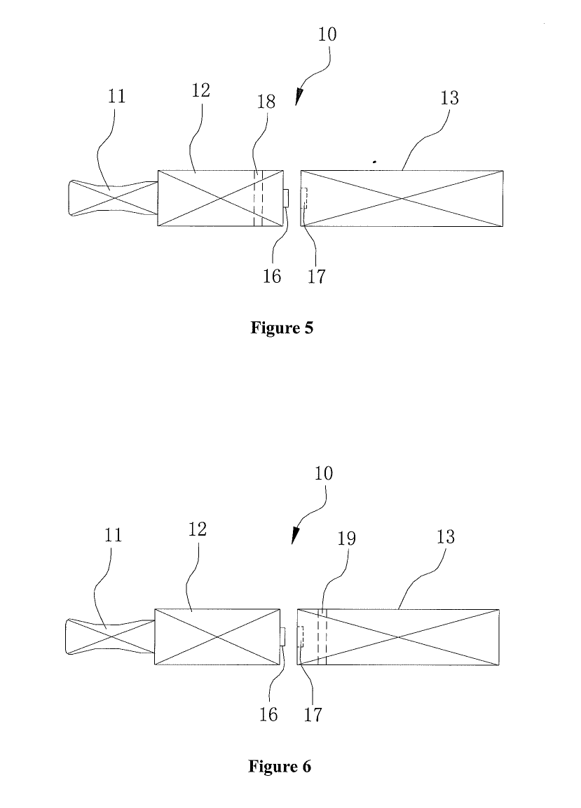

Referring to FIG. 5, the fifth embodiment and the second embodiment are largely identical but with minor differences. In particular, with regard to the fifth embodiment, the second embodiment can be referred, the fifth embodiment will not be described in detail, and it is different from the second embodiment, the differences lie in:

The magnetic connecting end of the atomizer component 12 is provided with a magnetic part 18, the magnetic connecting end of the power supply component 13 is a metallic connecting end attracted by the magnetic part 18 which is a permanent magnet, not only the permanent magnet is easy to get and is moderate in price, but also the connection and separation between the atomizer component 12 and the power supply component 13 can be ensured through the attraction between the first magnetic part 18 and the metallic connecting end. At the same time, comparing with the second embodiment, only the atomizer component 12 is provided with the magnetic part 18 according to this embodiment, materials for the electronic cigarette can be saved, and the cost is reduced.

Preferably, the metallic connecting end can be made from iron, nickel or cobalt. It should be understood that an alloy made from any two of or three of iron, nickel and cobalt can be used for the metallic connecting end.

A Sixth Embodiment:

Referring to FIG. 6, the sixth embodiment and the fifth embodiment are largely identical but with minor differences. In particular, with regard to the sixth embodiment, the fifth embodiment can be referenced, the sixth embodiment will not be described in detail, and it is different from the fifth embodiment, the differences lie in:

The magnetic connecting end of the power source component 13 is provided with a magnetic part 19, the magnetic connecting end of the atomizer component 12 is a metallic connecting end attracted b y the magnetic part 19 which is a permanent magnet, not only the permanent magnet is easy to get and is moderate in price, but also the connection and separation between the atomizer component 12 and the power supply component 13 can be ensured through the attraction between the magnetic part 19 and the metallic connecting end.

Preferably, the metallic connecting end can be made from iron, nickel or cobalt. It should be understood that an alloy made from any two of or three of iron, nickel and cobalt can be used for the metallic connecting end.

What described above are only preferred embodiments of the present invention, therefore, any modifications, equivalent replacements and improvements etc. made within the spirit and principle of the present invention, should be included in the protection scope of the present invention.

1. An electronic cigarette using a magnetic connection, wherein the electronic cigarette comprises a mouth-piece, an atomizer component and a power supply component, the mouth-piece is arranged at an end of the atomizer component, the other end of the atomizer component is magnetically connected to an end of the power supply component.

2. The electronic cigarette using a magnetic connection according to claim 1, wherein a first magnetic part is arranged in the magnetic connecting end of the atomizer component, a second magnetic part attracted by the first magnetic part is arranged in the magnetic connecting end of the power supply component, the atomizer component is magnetically connected to the power supply component by the attraction between the first magnetic part and the second magnetic part.

3. The electronic cigarette using a magnetic connection according to claim 1, wherein a magnetic part is arranged in the magnetic connecting end of the atomizer component, the magnetic connecting end of the power supply component is a metallic connecting end attracted by the magnetic part.

4. The electronic cigarette using a magnetic connection according to claim 1, wherein a magnetic part is arranged in the magnetic connecting end of the power supply component, the magnetic connecting end of the atomizer component is a metallic connecting end attracted by the magnetic part.

5. The electronic cigarette using a magnetic connection according to claim 1, wherein both magnetic connecting ends of the atomizer component and the power supply component are flat.

6. The electronic cigarette using a magnetic connection according to claim 1, wherein a magnetic connecting end of the atomizer component is provided with a protrusion, a groove is defined in a magnetic connecting end of the power supply component, the protrusion is engaged in the groove via a fastening connection.

7. The electronic cigarette using a magnetic connection according to claim 1, wherein a groove is defined in a magnetic connecting end of the atomizer component, a magnetic connecting end of the power supply component is provided with a protrusion, the protrusion is engaged in the groove via a fastening connection.

8. The electronic cigarette using a magnetic connection according to claim 1, wherein a magnetic connecting end of the atomizer component is connected to a magnetic connecting end of the power supply component via a plurality of fastening connections.

9. The electronic cigarette using a magnetic connection according to claim 8, wherein the magnetic connecting end of the power supply component is provided with a first protrusion, a second groove is defined in the first protrusion, a first groove correspondingly connected to the first protrusion via a fastening connection is defined in the magnetic connecting end of the atomizer component, the first groove is provided with a second protrusion correspondingly connected to the second groove via a fastening connection.

10. The electronic cigarette using a magnetic connection according to claim 8, wherein the magnetic connecting end of the atomizer component is provided with a first protrusion, a second groove is defined in the first protrusion, a first groove correspondingly engaged with the first protrusion via a fastening connection is defined in the magnetic connecting end of the power supply component, the first groove is provided with a second protrusion correspondingly engaged in the second groove via a fastening connection.
